(19) United States
(12) Patent Application Publication
(10) Pub. No.: US 2020/0117312 A1
(43) Pub. Date: Apr. 16, 2020

(54) TOUCH SCREEN INCLUDING AN INSPECTION LINE AND A DISPLAY DEVICE HAVING THE SAME

(71) Applicant: Samsung Display Co., Ltd., Yongin-Si (KR)

(72) Inventor: SEON HYE KIM, Yongin-Si (KR)

(21) Appl. No.: 16/537,684

(22) Filed: Aug. 12, 2019

(30) Foreign Application Priority Data
Oct. 12, 2018 (KR) 10-2018-0122063

(51) Int. Cl. G06F 3/044; G06F 3/041

(52) U.S. Cl. CPC G06F 3/0446; G06F 2203/04112; G06F 3/0412; G06F 3/0448

(57) ABSTRACT

A touch screen and a display device having the same are disclosed. The touch screen includes an insulating substrate including a sensing region and a peripheral region. A plurality of sensing electrodes are disposed in the sensing region of the insulating substrate. A plurality of metal lines are disposed in the peripheral region of the insulating substrate and electrically connect to the plurality of sensing electrodes. A plurality of pads are disposed in the peripheral region of the insulating substrate and electrically connect to the plurality of metal lines. A first protective layer is overlapping the peripheral region of the insulating substrate and includes the plurality of metal lines. An inspection line is disposed on the first protective layer, and a second protective layer is disposed on the inspection line and the first protective layer.

### CROSS-REFERENCE TO RELATED APPLICATION

The application claims priority from and the benefit of Korean Patent Application No. 10-2018-0122063, filed Oct. 12, 2018, which is incorporated by reference herein in its entirety.

### TECHNICAL FIELD

The present disclosure relates to a touch screen and a display device having the same, and more particularly, to a touch screen including an inspection line and a display device having the same.

### DISCUSSION OF RELATED ART

Flat panel display devices such as liquid crystal display devices (LCDs) and organic light emitting display devices (OLEDs) are thin and lightweight. Since a flat panel display device has a small thickness and weight, its range of various uses is gradually expanding. In recent years, a flat panel display device having a touch screen has been introduced in accordance with user demand. Since flat panel display devices have complicated structures, function and high cost, it is important to detect defects early on in the manufacturing process to increase efficiency and device integrity.

### SUMMARY

Exemplary embodiments of the present inventive concept provide a touch screen capable of easily implementing a defect detection unit without adding masks or process steps, and a display device having the same.

According to an exemplary embodiment of the present inventive concept, a touch screen may include an insulating substrate including a sensing region and a peripheral region. A plurality of sensing electrodes are disposed in the sensing region of the insulating substrate. A plurality of metal lines are disposed in the peripheral region of the insulating substrate and electrically connect to outermost ones of the plurality of sensing electrodes. A plurality of pads are disposed in the peripheral region of the insulating substrate and electrically connect to the plurality of metal lines. A first protective layer overlaps the peripheral region of the insulating substrate including the plurality of metal lines. An inspection line is disposed on the first protective layer. A second protective layer is disposed on the inspection line and the first protective layer.

According to an exemplary embodiment of the present inventive concept, a display device includes a first insulating substrate including a display region and a peripheral region. A display unit is disposed in the display region of the first insulating substrate configured to display an image. A second insulating substrate is disposed on the first insulating substrate and includes a sensing region overlapping the display region of the first insulating substrate and a peripheral region outside the sensing region. A plurality of sensing electrodes are disposed in the sensing region of the second insulating substrate. A plurality of metal lines are disposed in the peripheral region of the second insulating substrate and are electrically connected to the plurality of sensing electrodes. A plurality of pads are disposed in the peripheral region of the second insulating substrate and are electrically connected to the plurality of metal lines. A first protective layer overlaps the peripheral region of the second insulating substrate including the plurality of metal lines. An inspection line is disposed on the first protective layer, and a second protective layer is disposed on the inspection line and the first protective layer.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a plan view illustrating a touch screen according to an exemplary embodiment of the present inventive concept;

FIG. 2 is a cross-sectional view taken along line X1-X2 of FIG. 1 according to an exemplary embodiment of the present inventive concept;

FIGS. 3A and 3B are enlarged sectional views of peripheral region 140 of FIG. 2 according to an exemplary embodiment of the present inventive concept;

FIG. 4 is a plan view illustrating a touch screen according to an exemplary embodiment of the present inventive concept;

FIG. 5 is a cross-sectional view taken along line X11-X12 of FIG. 4 according to an exemplary embodiment of the present inventive concept;

FIG. 6 is a cross-sectional view illustrating a display device according to an exemplary embodiment of the present inventive concept;

FIG. 7 is a plan view illustrating the display panel of FIG. 6 according to an exemplary embodiment of the present inventive concept; and

FIG. 8 is a cross-sectional view illustrating an example of a pixel according to an exemplary embodiment of the present inventive concept.

### DETAILED DESCRIPTION OF THE EMBODIMENTS

Exemplary embodiments of the present inventive concept will now be described more fully with reference to the accompanying drawings. However, the exemplary embodiments hereinafter described are included for illustrative purposes. It is understood that the inventive concept may take on alternate embodiments, shapes, and proportions without departing from the spirit or scope of the inventive concept. The included embodiments can also be modified in various ways from that which is illustrated in the figures. The terms first, second, etc. as used herein should not be construed in a limiting sense, and are used for the purpose of distinguishing elements from one another. It shall be understood that when elements are referred to as being “connected” to one another, those elements may be either directly connected or intervening elements may be present therebetween. Additionally, it shall be understood that the sizes of the elements shown in the drawings may be exaggerated or reduced for convenience of description. Like reference numerals may refer to like elements throughout the detailed description and figures.

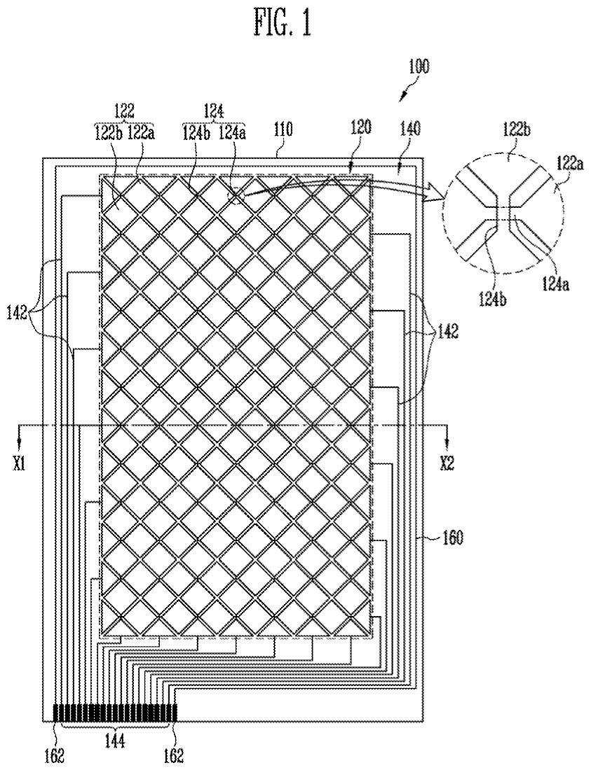

FIG. 1 is a plan view illustrating a touch screen according to an exemplary embodiment of the present inventive concept.

Referring to FIG. 1, a touch screen 100 may include an insulating substrate 110, a touch sensing unit disposed on the insulating substrate 110, a signal input and output unit, and a defect detection unit. The insulating substrate 110 may include a sensing region 120 and a peripheral region 140. The sensing region 120 may be defined as a central region of the insulating substrate 110. The peripheral region 140 may be defined as an outer region of the insulating substrate 110 that at least partially surrounds the sensing region 120.

The insulating substrate 110 may include a rigid substrate made of transparent glass, quartz, plastic or the like in the form of a plate, and/or may include a flexible substrate made of a transparent plastic in the form of a film. The transparent glass may include alumino silicate or soda lime, and the transparent plastic may include a polyimide resin, an acrylic resin, a polyacrylate resin, a polycarbonate resin, a polyether resin, a polyethylene terephthalate resin, and/or a sulfonic acid resin.

The touch sensing unit may include sensing electrodes 122 disposed in the sensing region 120 of the insulating substrate 110 and connection patterns 124 for connecting the sensing electrodes 122 to each other. The sensing electrodes 122 may include first sensing electrodes 122a arranged in a first direction (e.g., the row direction) and second sensing electrodes 122b arranged in a second direction (e.g., in the column direction) intersecting the first direction. For example, the second sensing electrodes 122b may have a staggered orientation with respect to the first sensing electrodes 122a. The first sensing electrodes 122a and the second sensing electrodes 122b may be arranged in a plurality of rows and columns so as not to overlap each other.

The sensing electrodes 122 may include a transparent conductive material such as indium tin oxide (ITO), zinc tin oxide (ZTO), gallium zinc oxide (GZO), carbon Nanotubes (CNTs), and/or graphene. In addition, the sensing electrodes 122 may be formed in various shapes, including a rectangular shape, a rhombic shape, amongst many others, and each shape may include a mesh structure.

The connection patterns 124 may include first connection patterns 124a for connecting the first sensing electrodes 122a in the first direction, and second connection patterns 124b for connecting the second sensing electrodes 122b in the second direction. The first connection patterns 124a and the second connection patterns 124b may intersect each other and may be electrically insulated from each other by an insulating layer disposed at intersections. The connection patterns 124 may include a transparent conductive material such as the sensing electrodes 122 and/or a metal having a higher conductivity than the transparent conductive material alone. The metal may include aluminum (Al), titanium (Ti), gold (Au), silver (Ag), copper (Cu), chromium (Cr), molybdenum (Mo), iron (Fe), molybdenum-tungsten (MoW) and/or nickel (Ni).

For example, the first sensing electrodes 122a and the first connection patterns 124a may be formed of different materials and formed in separate patterns from each other. In addition, the second sensing electrodes 122b and the second connection patterns 124b may include the same material and may be formed in an integrated pattern. In this case, the first sensing electrodes 122a, the second sensing electrodes 122b, and the second connection patterns 124b may each be formed of a transparent conductive material, and the first connection patterns 124a may be formed of a metal having a higher conductivity than the transparent conductive material.

The signal input and output unit may include lines 142 disposed in the peripheral region 140 of the insulating substrate 110 and pads 144 electrically connected to the lines 142. One side of each of the lines 142 may be electrically connected to either an outermost first sensing electrode 122a from among each row of the plurality of rows, or an outermost second sensing electrode 122b from among the plurality of columns. The other side of each of the lines 142 may be electrically connected to each of the pads 144.

The lines 142 may be formed of the same transparent conductive material as the sensing electrodes 122, or may include a metal having high conductivity, such as the material of the first connection patterns 124a. According to an exemplary embodiment of the present inventive concept, the lines 142 may include a laminated structure of a metal having a high conductivity and a transparent conductive material. The pads 144 may be formed of the same material as the lines 142. Thus, the sensing electrodes 122 may be electrically connected to an external driving circuit, such as a position detection circuit, via the lines 142 and the pads 144. The defect detection unit may include an inspection line 160 disposed in the peripheral region 140 of the insulating substrate 110 and inspection pads 162 electrically connected to the inspection line 160. The inspection line 160 may be disposed in the peripheral region 140 of the insulating substrate 110 so as not to overlap the lines 142. For example, the inspection line 160 may be disposed between the lines 142, or disposed outside the lines 142 in parallel. According to an exemplary embodiment of the present inventive concept, a single inspection line 160 is provided. The inspection line 160 may be implemented in a continuous linear shape corresponding to all sides of the insulating substrate 110. For example, the single inspection line 160 may have ends connected to the inspection pads 162 and may extend along the perimeter of the insulating substrate 110. However, according to an exemplary embodiment of the present inventive concept, the inspection line 160 may include a discontinuous linear shape and/or may correspond to less than all sides of the insulating substrate 110. For example, the inspection line 160 may include kinked or bent portions, such as a zig-zag structure. However, a plurality of inspection lines 160 may be provided. According to an exemplary embodiment of the present inventive concept, an inspection line 160, electrically insulated from a line 140, may at least partially overlap the line 140 from a plan view perspective without contacting an associated sensing electrode 122 or the line 140.

Each of the inspection pads 162 may be disposed on one side or both sides of the pads 144 in the peripheral region 140 of the insulating substrate 110 and electrically connect to one end or both ends of the inspection line 160. The inspection line 160 may include the same material as the sensing electrodes 122, and the inspection pads 162 may include the same material as the lines 142. Additionally, the inspection line 160 and the inspection pads 162 may be electrically connected to each other through a contact hole formed in the insulating layer.

According to an exemplary embodiment of the present inventive concept, the inspection pads 162 are disposed outside the pads 144. However, according to another exemplary embodiment of the present inventive concept, the inspection pads 162 may be disposed between the pads 144 or spaced apart from the pads 144.

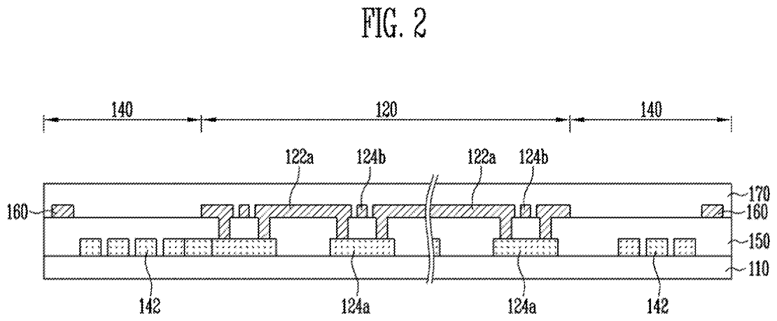

The touch screen 100 according to an exemplary embodiment of the present inventive concept will now be described in more detail with reference to FIG. 2. FIG. 2 is a cross-sectional view taken along line X1-X2 of FIG. 1.

Referring to FIGS. 1 and 2, the first connection patterns 124a may be arranged at a predetermined interval in the sensing region 120 of the insulating substrate 110 and the lines 142 may be arranged at a predetermined interval in the peripheral region 140 of the insulating substrate 110. The first connection patterns 124a and the lines 142 may include the same material as one another and they may be disposed on a same layer and a same plane.

A first protective layer 150 may be disposed on the insulating substrate 110 including the first connection patterns 124a and the lines 142. The first protective layer 150 may include contact holes exposing both side portions of the first connection patterns 124a.

The first sensing electrodes 122a, the second sensing electrodes 122b and the second connection patterns 124b are disposed on the first protective layer 150 of the sensing region 120. The inspection line 160 may be disposed on the first protective layer 150 of the peripheral region 140. The first sensing electrodes 122a may be electrically connected to the first connection patterns 124a through the contact holes of the first protective layer 150. In addition, the second sensing electrodes 122b and the second connection patterns 124b may be connected to each other as an integrated pattern. The second sensing electrodes 122b and the second connection patterns 124b may be arranged between the first sensing electrodes 122a and electrically isolated from the first sensing electrodes 122a. In addition, the inspection line 160 may be disposed on the first protective layer 150 without overlapping the lines 142. For example, the inspection line 160 may be disposed on the first protective layer 150 between the lines 142 or outside the lines 142.

A second protective layer 170 may be disposed on the first sensing electrodes 122a, the second sensing electrodes 122b, the second connection patterns 124b, the inspection line 160 and the first protective layer 150. The first and second protective layers 150 and 170 may include a transparent insulating material, for example, silicon oxide (SiO₂), and may have a thickness of about 2000 Å to about 4000 Å.

The touch screen 100 according to an exemplary embodiment of the present inventive concept is an example of a capacitance type touch screen. When an object such as a human hand or a pen touches the sensing region 120, a change in capacitance at a position where the object is in contact may be sensed by the sensing electrodes 122. The change in the capacitance is provided to a driving circuit via the lines 142 and the pads 144. The change in the capacitance is converted into an electrical signal so that the position of the contact input can be detected.

A defect may occur on a surface of the second protective layer 170 in a manufacturing process of the touch screen 100. In particular, the peripheral region 140 of the insulating substrate 110 may be vulnerable to scratches due to causes such as contact with manufacturing equipment.

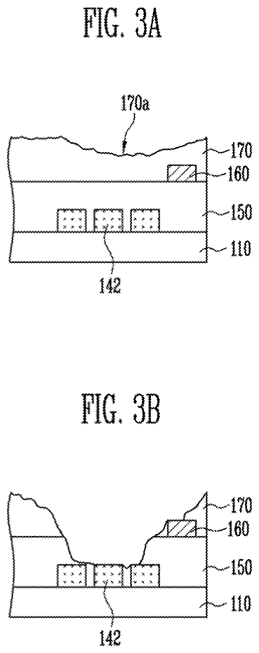

FIGS. 3A and 3B are enlarged sectional views of the peripheral region 140 of FIG. 2. Referring to FIG. 3A, a defect 170a may be induced by causes such as scratches that occur on a surface of the second protective layer 170 in the peripheral region 140 during a manufacturing process of the touch screen 100.

Referring to FIG. 3B, the second protective layer 170 and the first protective layer 150 may be eroded by moisture permeated through the defect 170a in a reliability test (high temperature and high humidity conditions) included in the manufacturing process. When surfaces of the lines 142 are exposed by the erosion, the exposed portions of the lines 142 may be corroded by contact with external moisture.

However, since such erosion and corrosion may occur slowly over a long period of time, it is not easy to detect deterioration of electrical characteristics or sense prospective failure due to the corrosion of the lines 142 early on in the manufacturing process. If defects or corrosion as described above worsen during consumer use of the product, reliability of a manufacturer's products may be lowered and economic loss may be incurred. Therefore, it is very important to detect defects early in the manufacturing process to prevent shipment of defective display devices with low reliability and product lifetime. To this end, the touch screen 100 according to the exemplary embodiment of the present inventive concept includes a defect detection unit that can detect defects early on in the manufacturing process.

The defect 170a as shown in FIG. 3A may occur in the shape of a continuous line or discontinuous points. Accordingly, not only the lines 142 but also the inspection line 160 may be corroded as shown in FIG. 3B.

When the manufacture of the touch screen 100 is completed, a probe of an inspection apparatus is brought into contact with the inspection line 160 or the inspection pads 162 to measure a self-resistance value, an amount of current or an amount of charge of the inspection line 160. In a case where defects or corrosion occurs as described above, the self-resistance value of the inspection line 160 may increase, and the amount of current or the amount of charge of the inspection line 160 may decrease. Since the inspection line 160 is positioned closer to the surface of the second protective layer 170 than the lines 142, the possibility of a defect of the lines 142 may be easily predicted through a defect detected by the inspection line 160.

When a change of the self-resistance value, the amount of current, or the amount of charge of the inspection line 160 is beyond a reference point, it is determined that the touch screen 100 is defective, so that the shipment of defective product can be prevented. Such an inspection may be performed not only during the manufacturing process of the touch screen 100, but also during a module state in which the touch screen 100 is assembled together with a display panel and mounted in a mold frame or a case. Therefore, it is possible to prevent the shipment of a defective product through multi-stage inspection.

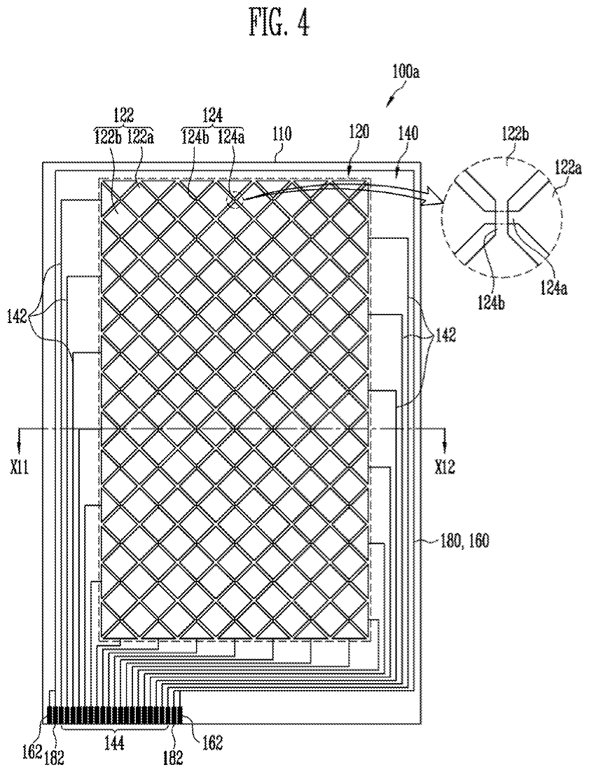

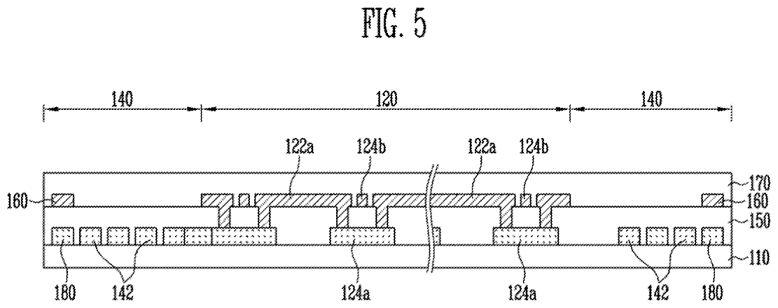

FIG. 4 is a plan view illustrating a touch screen according to an exemplary embodiment of the present inventive concept. FIG. 5 is a cross-sectional view taken along line X11-X12 of FIG. 4.

A touch screen 100a according to an exemplary embodiment of the present inventive concept has basically the same structure as the touch screen 100 according to the exemplary embodiment of the present invention of FIG. 1. Therefore, explanation of repeated elements previously described will be omitted for brevity of description.

Referring to FIGS. 4 and 5, the touch screen 100a may further include an antistatic guard ring 180. The antistatic guard ring 180 may be disposed on the peripheral region 140 outside the lines 142. The inspection line 160 may be disposed on the first protective layer 150 overlapping the antistatic guard ring 180.

For example, the antistatic guard ring 180 may be formed on the insulating substrate 110 in the process of forming the lines 142. The inspection line 160 may be formed on the first protective layer 150 in the process of forming the first sensing electrodes 122a, the second sensing electrodes 122b, and the second connection patterns 124b. One end or both ends of the antistatic guard ring 180 may be electrically connected to a pad 182. The pad 182 may be disposed on one side or both sides of the pads 144 in the peripheral region 140. The pad 182 may be electrically connected to a ground voltage such that electrostatic discharge may occur. The pad 182 may be formed on the insulating substrate 110 during the process of forming the pads 144.

When the inspection line 160 is disposed outside the lines 142, as in the first embodiment, the size of the peripheral region 140 may be increased. However, when the inspection line 160 overlaps the antistatic guard ring 180 as in the second embodiment, the defect detection unit may be easily implemented without increasing the size of the peripheral region 140.

The touch screen according to an exemplary embodiment of the present inventive concept may be used as an input device in combination with a display device or the like. In the following embodiments, the touch screen 100 of FIG. 1 is taken as an example, but the touch screen 100a of FIG. 4 may be applied in the same manner.

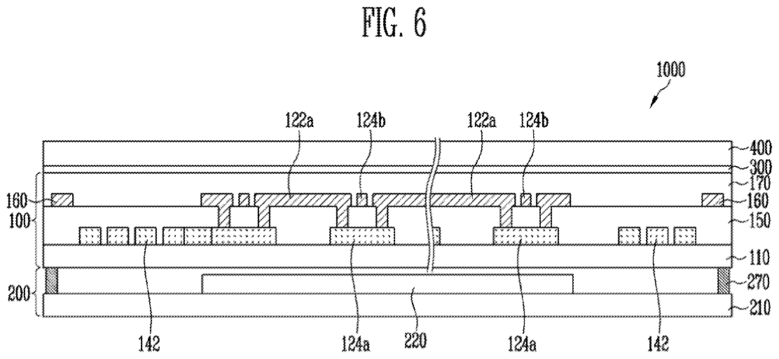

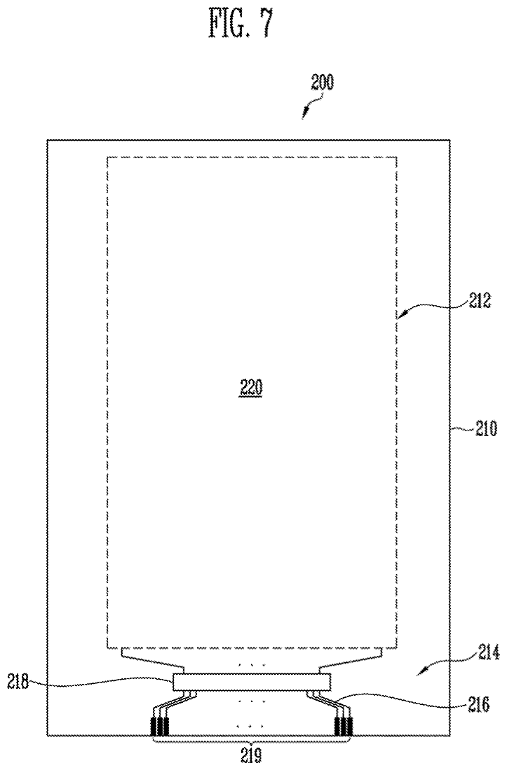

FIG. 6 is a cross-sectional view illustrating a display device according to an exemplary embodiment of the present inventive concept and FIG. 7 is a plan view illustrating a display panel of FIG. 6.

Referring to FIG. 6, a display device 1000 may include a display panel 200 for displaying an image, a touch screen 100 disposed on the display panel 200, an optical adhesive layer 300 disposed on the touch screen 100, and a window member 400 disposed on the optical adhesive layer 300. For example, the optical adhesive layer may be disposed on the second protective layer and a window member may be disposed on the optical adhesive layer.

Referring to FIGS. 6 and 7, the display panel 200 may include an insulating substrate 210 and a display unit 220 disposed on the insulating substrate 210 that displays an image. The insulating substrate 210 may be a rigid substrate including transparent glass, quartz, plastic or the like in the form of a plate, and/or a flexible substrate made of a transparent plastic or the like in the form of a film. The insulating substrate 210 may include a display region 212 and a peripheral region 214. The display region 212 may be defined as a central region of the insulating substrate 210. The peripheral region 214 may be defined as an outer region of the display region 212. For example, the peripheral region 214 may at least partially surround the display region 212.

The display unit 220 for displaying an image may be disposed in the display region 212 of the insulating substrate 210. Pads 219 for receiving a signal for driving the display unit 220, and signal lines 216 for electrically connecting the pads 219 and the display unit 220 may be disposed in the peripheral region 214 of the insulating substrate 210. A driving unit 218 for generating a scan signal or a data signal for driving the display unit 220 may be connected to an middle portion of the signal lines 216. The display unit 220 may include a pixel array for displaying an image. The pixel array may include a plurality of pixels connected in a matrix form between scan lines and data lines. Each of the plurality of pixels may include a light emitting element and a pixel circuit for driving the light emitting element. The pixel circuit may include a thin film transistor for transmitting a signal to the light emitting element and a capacitor for maintaining the signal.

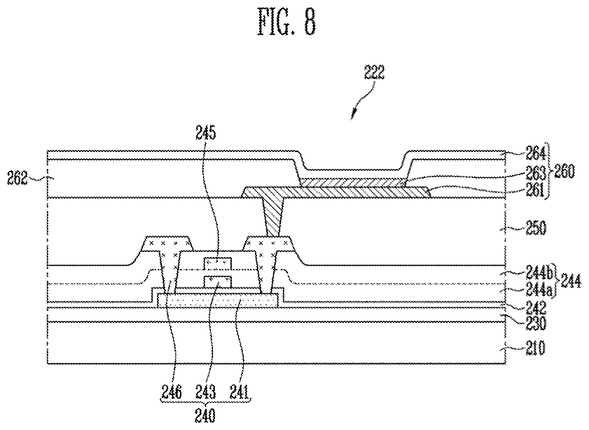

FIG. 8 is a cross-sectional view illustrating a pixel according to an exemplary embodiment of the present inventive concept.

A pixel 222 may be disposed in the display region 212 of the insulating substrate 210. A buffer layer 230 may be disposed on the insulating substrate 210 to prevent penetration of external air and to planarize a surface of the insulating substrate 210. A thin film transistor 240 may be disposed on the buffer layer 230.

The thin film transistor 240 may include a semiconductor layer 241 including a source region, a drain region and a channel region, a gate electrode 243 disposed on the semiconductor layer 241 in the channel region and electrically insulated from the semiconductor layer 241 by a gate insulating layer 242, and source and drain electrodes 246 electrically connected to the semiconductor layer 241 of the source and drain regions. The source and drain electrodes 246 may be electrically connected to the semiconductor layer 241 of the source and drain regions through contact holes formed in an interlayer insulating layer 244. The interlayer insulating layer 244 may include a first interlayer insulating layer 244a and a second interlayer insulating layer 244b disposed on the first interlayer insulating layer 244a.

A capacitor electrode 245 may be disposed between the first interlayer insulating layer 244a and the second interlayer insulating layer 244b overlapping the gate electrode 243. The gate electrode 243, the first interlayer insulating layer 244a, and the capacitor electrode 245 may overlap each other and collectively define the capacitor. A light emitting element 260 may be disposed on the upper portion of the thin film transistor 240 and the capacitor. The light emitting element 260 may include, for example, an organic light emitting diode (OLED). A planarization layer 250 may be disposed on the insulating substrate 210 overlapping the thin film transistor 240 and the capacitor. A first electrode 261 may be disposed on the planarization layer 250, for example, as an anode electrode of the light emitting element 260. The first electrode 261 may be electrically connected to the source or drain electrode 246 through a via hole formed in the planarization layer 250. A pixel defining layer 262 may be disposed on the planarization layer 250 including the first electrode 261 so that the first electrode 261 of a light emitting region is exposed. An organic thin film layer 263 may be disposed on an exposed surface of the first electrode 261. The organic thin film layer 263 may include a hole injecting layer, a hole transporting layer, an organic light emitting layer, an electron transporting layer, and an electron injecting layer.

According to an exemplary embodiment of the present inventive concept, the organic thin film layer 263 may further include an auxiliary layer or an intermediate layer. A second electrode 264 may be disposed on the pixel defining layer 262 including the organic thin film layer 263, for example, as a cathode electrode of the light emitting element 260. Although an organic light emitting display device has been described in previously described exemplary embodiments of the present inventive concept, the display device may also include a liquid crystal display device.

The display device 1000 according to an exemplary embodiment of the present inventive concept may include a control unit. The control unit may receive a synchronizing signal and a clock signal from outside, generate a control signal, and provide the control signal to the driving unit 218.

The pixel 222 may be selected by a scan signal provided through the scan line. Current flowing through the pixel 222 may be controlled in accordance with a data signal provided through the data line so that the pixel 222 may emit light of a predetermined brightness corresponding to the data signal.

The touch screen 100 may be disposed on the upper portion of the display panel 200. The touch screen 100 may be disposed on the display panel 200 such that the sensing region 120 of the touch screen 100 overlaps the display region 212 of the display panel 200. For example, the display unit 222 may be disposed between the insulating substrate 210 of the display panel 200 as a first insulating substrate and the insulating substrate 110 of the touch screen 100 as a second insulating substrate. A sealing member 270 may be interposed between the insulating substrate 210 and the insulating substrate 110 so as to at least partially surround the display unit 222. The insulating substrate 210 and the insulating substrate 110 may be connected to each other by the sealing member 270.

According to an exemplary embodiment of the present inventive concept, the display unit 220 may be sealed with an encapsulation layer of a laminated structure, including an organic layer and/or an inorganic layer. The display device 1000 may display an image through the display unit 220 and the touch screen 100 may be used as an input device in a state that the image is displayed. As described with reference to the touch screens 100 and 100a of FIGS. 1 and 4, according to an exemplary embodiment of the present inventive concept, defects to the touch screen 100 of the display device 1000 can be detected early on in the manufacturing process. Since defects can be detected early in the manufacturing process of the touch screen, the reliability of the manufacturer's devices may increase, and consequently reputational damage due to shipment of defective products can be effectively prevented. Further, since the inspection line and the inspection pad constituting the defect detection unit can be implemented without an additional mask or process step, no additional manufacturing cost or process time is required to implement an additional function.

Although the exemplary embodiments of the present invention have been described, it is understood that the present inventive concept is not be limited to the exemplary embodiments described, and that various changes and modifications can be made by one ordinary skilled in the art within the spirit and scope of the present inventive concept.

What is claimed is:

1. A touch screen, comprising:
an insulating substrate including a sensing region and a peripheral region;
a plurality of sensing electrodes disposed in the sensing region of the insulating substrate;
a plurality of metal lines disposed in the peripheral region of the insulating substrate and electrically connected to outermost ones of the plurality of sensing electrodes;
a plurality of pads disposed in the peripheral region of the insulating substrate and electrically connected to the plurality of metal lines;
a first protective layer overlapping the peripheral region of the insulating substrate including the plurality of metal lines;
an inspection line disposed on the first protective layer; and
a second protective layer disposed on the inspection line and the first protective layer.

2. The touch screen of claim 1, further comprising:
an inspection pad disposed on one side of the plurality of pads and electrically connected to the inspection line.

3. The touch screen of claim 2, wherein the inspection pad includes a same material as a material included in the plurality of metal lines.

4. The touch screen of claim 3, wherein the plurality of metal lines and the inspection pad include Al, Ti, Au, Ag, Cu, Cr, Mo, Fe, MoW and/or Ni.

5. The touch screen of claim 1, further comprising:
an antistatic guard ring disposed in the peripheral region of the insulating substrate outside the plurality of metal lines.

6. The touch screen of claim 5, wherein the inspection line is disposed on the first protective layer overlapping the antistatic guard ring.

7. The touch screen of claim 1, wherein the inspection line includes a same material as a material included in the plurality of sensing electrodes.

8. The touch screen of claim 7, wherein the plurality of sensing electrodes and the inspection line include indium tin oxide (ITO), zinc tin oxide (ZTO), zinc gallium oxide (GZO), carbon nanotube (CNT) and/or graphene.

9. The touch screen of claim 1, wherein the first and second protective layers include a silicon oxide (SiO₂).

10. A display device, comprising:
a first insulating substrate including a display region and a peripheral region;
a display unit disposed in the display region of the first insulating substrate and configured to display an image;
a second insulating substrate disposed on the first insulating substrate and including a sensing region overlapping the display region of the first insulating substrate and a peripheral region outside the sensing region;
a plurality of sensing electrodes disposed in the sensing region of the second insulating substrate;
a plurality of metal lines disposed in the peripheral region of the second insulating substrate and electrically connected to the plurality of sensing electrodes;
a plurality of pads disposed in the peripheral region of the second insulating substrate and electrically connected to the plurality of metal lines;
a first protective layer overlapping the peripheral region of the second insulating substrate including the plurality of metal lines;
an inspection line disposed on the first protective layer; and
a second protective layer disposed on the inspection line and the first protective layer.

11. The display device of claim 10, further comprising:
a sealing member disposed between the first insulating substrate and the second insulating substrate and surrounding the display unit.

12. The display device of claim 10, further comprising:
an optical adhesive layer disposed on the second protective layer; and
a window member disposed on the optical adhesive layer.

13. The display device of claim 10, further comprising:
an inspection pad disposed on one side of the plurality of pads and electrically connected to the inspection line.

14. The display device of claim 13, wherein the inspection pad includes a same material as a material included in the plurality of metal lines.

15. The display device of claim 14, wherein the plurality of metal lines and the inspection pad include Al, Ti, Au, Ag, Cu, Cr, Mo, Fe, MoW and/or Ni.

16. The display device of claim 10, further comprising:
an antistatic guard ring disposed in the peripheral region of the second insulating substrate outside the plurality of metal lines.

17. The display device of claim 16, wherein the inspection line is disposed on the first protective layer overlapping the antistatic guard ring.

18. The display device of claim 10, wherein the inspection line includes a same material as a material included in the plurality of sensing electrodes.

19. The display device of claim 18, wherein the plurality of sensing electrodes and the inspection line include indium tin oxide (ITO), zinc tin oxide (ZTO), zinc gallium oxide (GZO), carbon nanotube (CNT) and/or graphene.

20. The display device of claim 10, wherein the first and second protective layers include a silicon oxide (SiO₂).
